(19) United States
(12) Patent Application Publication
(10) Pub. No.: US 2022/0138282 A1
(43) Pub. Date: May 5, 2022

(54) COMPUTING DEVICE AND COMPUTING METHOD

(71) Applicant: KABUSHIKI KAISHA TOSHIBA, Tokyo (JP)

(72) Inventor: Koichiro BAN, Kawasaki (JP)

(73) Assignee: KABUSHIKI KAISHA TOSHIBA, Tokyo (JP)

(21) Appl. No.: 17/408,746

(22) Filed: Aug. 23, 2021

(30) Foreign Application Priority Data
Nov. 4, 2020 (JP) 2020-184482

(51) Int. Cl. G06F 17/16; G06F 7/50; G06F 7/523

(52) U.S. Cl. CPC G06F 17/16; G06F 7/523; G06F 7/50

(57) ABSTRACT

A computing device includes processing circuitry and control circuitry. The processing circuitry computes an M×K-dimensional first output matrix being a product of an M×P-dimensional first input matrix and a P×K-dimensional second input matrix, computes an M×K-dimensional cumulative addition matrix by adding a first output matrix and an M×K-dimensional matrix to store the M×K-dimensional cumulative addition matrix in a cumulative register, compute an addition vector by adding each of M-dimensional cumulative addition vectors included in the cumulative addition matrix and an M-dimensional temporary vector to store the addition vector in each vector register, and output the temporary vector from an M-th one of the vector registers, and perform a vector operation to the output temporary vector to output an output vector. The control circuitry controls the computation instructions as to the computations.

### CROSS-REFERENCE TO RELATED APPLICATIONS

This application is based upon and claims the benefit of priority from Japanese Patent Application No. 2020-184482, filed on Nov. 4, 2020; the entire contents of which are incorporated herein by reference.

### FIELD

Embodiments described herein relate generally to a computing device and a computing method.

### BACKGROUND

Computing devices that execute matrix operations included in the arithmetic operation of a neural network have been known. For example, a technique of executing matrix multiplication by using a systolic array to reduce the latency of arithmetic operation is proposed.

Conventionally, however, it may not be possible to efficiently execute a matrix operation. In the case of using a systolic array as described above, it may require an overhead for loading a weight into the systolic array or extraneous resistors and data paths for shortening a length of weight loading time.

### BRIEF DESCRIPTION OF THE DRAWINGS

FIG. 1 is a block diagram of a computing device according to an embodiment;

FIG. 2 is a diagram illustrating an example of processing of a matrix-product computing unit;

FIG. 3 is a block diagram of an inner-product computing unit;

FIG. 4 is a diagram illustrating an example of processing of a cumulative adder;

FIG. 5 is a block diagram of a shift adder;

FIG. 6 is a block diagram of a vector computing unit;

FIG. 7 is a diagram illustrating an exemplary convolution operation by the computing device;

FIG. 8 is a diagram illustrating an exemplary pseudo programming code for use in a computing method;

FIG. 9 is a diagram illustrating an example of computing scheduling by the computing device;

FIG. 10 is a diagram illustrating an example of computing scheduling by the computing device;

FIG. 11 is a diagram for explaining a method of dividing a weight kernel into sub-kernels;

FIG. 12 is a diagram illustrating an example of data sorting process;

FIG. 13 is a diagram illustrating an exemplary convolution operation in the shift adder;

FIG. 14 is a diagram illustrating an exemplary configuration of data arrangement in a storage;

FIG. 15 is a diagram illustrating an exemplary configuration of data arrangement in the storage;

FIG. 16 is a diagram illustrating an exemplary graph of a neural network;

FIG. 17 is a flowchart illustrating a computation process of layers L1 to L3; and

FIG. 18 is a flowchart illustrating a computation process of a layer L4.

### DETAILED DESCRIPTION

According to one embodiment, in general, a computing device includes processing circuitry and control circuitry. The processing circuitry is configured to compute an M×K-dimensional first output matrix in response to a matrix product operation instruction, the M×K-dimensional first output matrix being a product of an M×P-dimensional first input matrix and a P×K-dimensional second input matrix where M, K, and P each represents an integer of two or more; compute an M×K-dimensional cumulative addition matrix in response to a cumulative addition instruction, and store the M×K-dimensional cumulative addition matrix in a cumulative register, the M×K-dimensional cumulative addition matrix representing a matrix obtained by adding the first output matrix and an M×K-dimensional matrix stored in the cumulative register; compute, in response to a vector addition instruction, an addition vector by adding each of M-dimensional cumulative addition vectors included in the cumulative addition matrix and an M-dimensional temporary vector stored in each of M vector registers, store the addition vector in each vector register, and output the temporary vector from an M-th one of the vector registers in response to a shift instruction; and perform an instructed vector operation to the output temporary vector and output an output vector as a result of the vector operation. The control circuitry is configured to control the matrix product operation instruction, the cumulative addition instruction, the vector addition instruction, the shift instruction, and the vector operation instruction.

Hereinafter, embodiments of a computing device according to this disclosure will be described in detail with reference to the accompanying drawings.

In the case of the conventional method using a systolic array as described above, it may not be possible to efficiently execute a matrix operation due to occurrence of an overhead for loading a weight into the systolic array. In addition, one matrix operation using the systolic array frequently results in a failure in completing output data of a convolution operation of a neutral network. Because of this, an extraneous memory for storing therein partial sums may be required.

In the following, a computing device according to an embodiment can perform matrix operation at a high speed without decreasing the efficiency (operation rate) of the matrix operation. The matrix operation applicable to the computing device of an embodiment may be any process. For example, the computing device of an embodiment can be configured to perform matrix operation included in the computation of the neutral network.

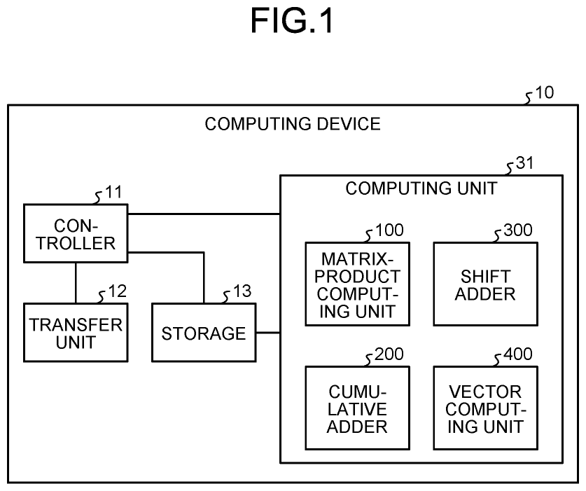

FIG. 1 is a block diagram illustrating an exemplary configuration of a computing device 10 according to a present embodiment. As illustrated in FIG. 1, the computing device 10 includes a controller 11, a transfer unit 12, a storage 13, and a computing unit 31.

The storage 13 stores therein various kinds of data for use in computation. The storage 13 can include any general-purpose storage medium such as a flash memory and a random-access memory (RAM).

The transfer unit 12 serves to transfer data between the computing device 10 and an exterior. The computing unit 31 is processing circuitry that performs computations including a matrix operation. The controller 11 sets and controls parameters of the respective elements (the storage 13, the transfer unit 12, and the computing unit 31).

The controller 11 can be implemented as, for example, a central processor unit (CPU) or control circuitry including a dedicated command set for the transfer unit 12 and the computing unit 31. Each of the transfer unit 12 and the computing unit 31 can be implemented by independent hardware circuits or integrated hardware circuitry, for example. Part or all of the controller 11, the transfer unit 12, and the computing unit 31 may also be implemented by physically integrated hardware circuitry.

The computing unit 31 includes a matrix-product computing unit 100, a cumulative adder 200, a shift adder 300, and a vector computing unit 400.

The matrix-product computing unit 100 performs a matrix product operation in response to an instruction of the controller 11. For example, the matrix-product computing unit 100 computes an M×K-dimensional matrix (first output matrix) for output where M represents an integer of two or more and K represents an integer of two or more. The M×K-dimensional matrix is the product of an M×P-dimensional matrix (first input matrix) and a P×K-dimensional matrix (second input matrix) where P represents an integer of two or more.

An input matrix may be any matrix. The present embodiment will mainly describe the following matrices by way of example.

First input matrix: matrix obtained from feature map data (exemplary input feature data) including elements as features at each three-dimensional coordinate value in a vertical direction, a horizontal direction, and a channel direction. Hereinafter, such a matrix may be referred to as a feature map matrix.

Second input matrix: matrix obtained from weight data including elements as weights at each four-dimensional coordinate value in the vertical direction, the horizontal direction, the channel direction, and a kernel direction (output channel direction). For example, the second input matrix represents a matrix including elements corresponding to one coordinate in the horizontal direction, one coordinate in the vertical direction, P coordinates in the channel direction, and K coordinates in the kernel direction among the weight data. Hereinafter, such a matrix may be referred to as a weight matrix.

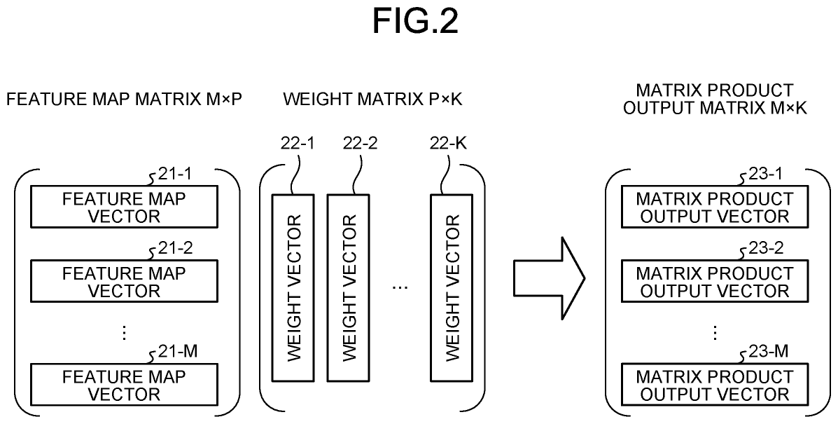

FIG. 2 is a diagram illustrating an example of processing by the matrix-product computing unit 100. The matrix-product computing unit 100 computes a matrix product of a feature map matrix and a weight matrix, which are read from the storage 13 in response to a read command from the controller 11, and outputs a resultant matrix-product output matrix (first output matrix).

The size of the feature map matrix is defined as M×P, the size of the weight matrix is defined as P×K, and the size of the matrix-product output matrix is defined as M×K. The feature map matrix includes M feature map vectors 21-1 to 21-M having a size P. The weight matrix includes K weight vectors 22-1 to 22-K having a size P. The matrix-product output matrix includes M matrix product output vectors 23-1 to 23-M having a size K.

When P is equal to K, these vectors all have the same size. In view of this, in the following, P is defined as equal to K for the sake of clear explanation, although this is not intended to limit the generality of the present embodiment. The sizes of a matrix and a vector signify not the bit width of each element but the numbers of elements in the matrix and the vector. As illustrated in FIG. 2, the computation process of the matrix-product computing unit 100 can be represented as a total of M×K inner product operations of M feature map vectors and K weight vectors. That is, the matrix-product computing unit 100 can include M×K inner-product computing units 110.

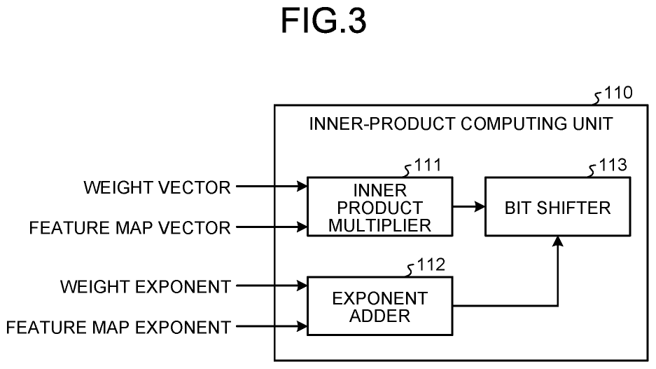

FIG. 3 is a block diagram illustrating an exemplary configuration of the inner-product computing unit 110 included in the matrix-product computing unit 100. The inner-product computing unit 110 includes an inner product multiplier 111, an exponent adder 112, and a bit shifter 113.

The inner-product computing unit 110 receives feature map vectors, weight vectors, feature map exponents, and weight exponents. In each of the feature map vectors and each of the weight vectors, K elements in the same vector are all encoded in a common fixed-point format and are accompanied by exponent data indicating the position of the decimal point. That is, one piece of exponent data is set for each vector, and each vector is encoded in an independently defined fixed-point format (may be in the same format or different formats). Exponent data of the feature map vector is referred to as a feature map exponent. Exponent data of the weight vector is referred to as a weight exponent.

Each of the M×K inner-product computing units 110 corresponds to the m-th (1≤m≤M) feature map vector (an exemplary first input vector) and the k-th (1≤k≤K) weight vector of mutually different combinations of m and k. For example, the inner product multiplier 111, the exponent adder 112, and the bit shifter 113, included in the inner-product computing unit 110 corresponding to the m-th feature map vector and the k-th weight vector, perform the following computations.

The inner product multiplier 111 computes an inner product of the m-th feature map vector and the k-th weight vector (an exemplary second input vector). The inner product includes multiplication and addition of an integer arithmetic (fixed-point arithmetic), which makes it possible to considerably reduce a circuit scale as compared with a floating-point arithmetic.

The exponent adder 112 computes an exponent value by adding a feature map exponent (an exemplary first exponent value) of the m-th feature map vector and a weight exponent (an exemplary second exponent value) of the k-th weight vector.

The bit shifter 113 bit-shifts the inner product (scalar value) computed by the inner product multiplier 111 in accordance with the exponent value computed by the exponent adder 112. Through the bit shifting, it is possible to align the decimal point positions in the fixed-point format of the outputs of the M×K inner-product computing units 110. In addition, one piece of exponent data is defined for K elements. Thus, in spite of a small overhead, numerical values can be expressed in a wider dynamic range as in the floating-point format. This makes it possible to significantly reduce the circuit scale.

Returning to FIG. 1, the cumulative adder 200 performs a matrix cumulative addition process. For example, following a cumulative addition instruction (cumulative addition command) from the controller 11, the cumulative adder 200 computes an M×K-dimensional cumulative addition matrix representing a matrix obtained by adding the matrix-product output matrix and an M×K-dimensional matrix stored in a cumulative register, and stores the resultant cumulative addition matrix in the cumulative register. The cumulative register is, for example, included in the cumulative adder 200 or the computing unit 31.

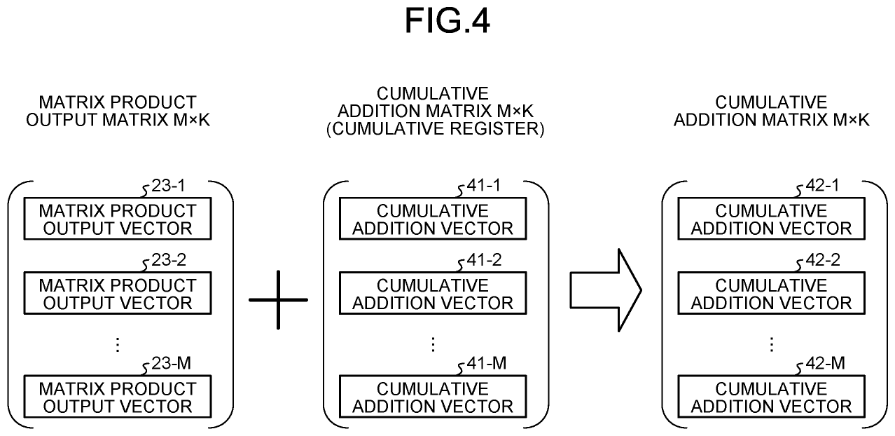

FIG. 4 is a diagram illustrating an example of the processing of the cumulative adder 200. In accordance with the cumulative addition command from the controller 11, the cumulative adder 200 performs a cumulative addition of the matrix-product output matrix (41-1 to 41-M) output from the matrix-product computing unit 100 and the cumulative addition matrix stored in the cumulative register, and sets the value stored in the cumulative register as an output value. With no value stored in the cumulative register, the cumulative adder 200 may also input the matrix-product output matrix to the cumulative register. The matrix (matrix-product output matrix) input to the cumulative adder 200 and the matrix (cumulative addition matrix) output from the cumulative adder 200 have the same size of (M×K).

Returning to FIG. 1, the shift adder 300 performs shift addition to the output of the cumulative adder 200. For example, in response to a vector addition instruction (addition command) from the controller 11, the shift adder 300 computes an addition vector by adding each of M×K-dimensional cumulative addition vectors included in the cumulative addition matrix and an M-dimensional temporary vector stored in each of M vector registers, and stores the resultant addition vector in the vector register. Further, the shift adder 300 outputs the temporary vector from the vector register in response to a shift instruction (shift command) from the controller 11.

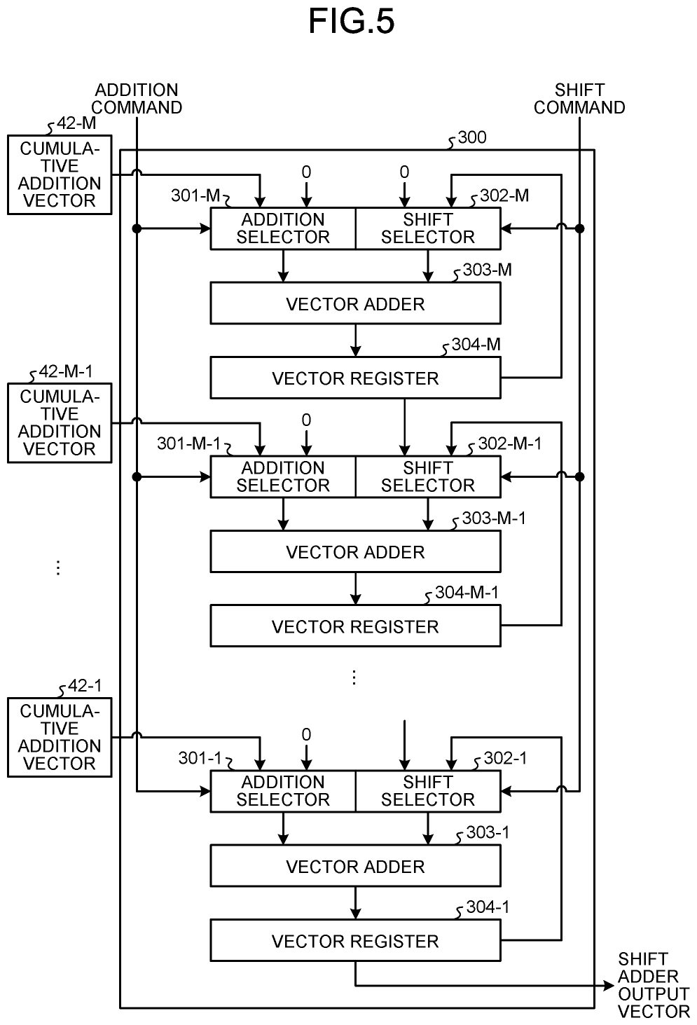

FIG. 5 is a block diagram illustrating an exemplary configuration of the shift adder 300. The shift adder 300 includes addition selectors 301-1 to 301-M, shift selectors 302-1 to 302-M, vector adders 303-1 to 303-M, and vector registers 304-1 to 304-M.

The addition selectors 301-1 to 301-M and the shift selectors 302-1 to 302-M serve to switch input signals to the vector adders 303-1 to 303-M. The vector adders 303-1 to 303-M serve to add vectors. The vector registers 304-1 to 304-M store therein respective vectors.

The shift adder 300 serves to add the vector (cumulative addition vector) included in the cumulative addition matrix output from the cumulative adder 200 and each vector in the vector registers 304-1 to 304-M, in response to the addition command from the controller 11. The shift adder 300 also performs shifting to the vector registers 304-1 to 304-M in response to the shift command from the controller 11. In the shifting process, the shift adder 300 outputs a vector as an output vector from the vector register 304-1 located at an end.

The addition selector 301-m (m=1 to M) outputs a cumulative addition vector 42-m in response to a valid addition command, and outputs a zero vector otherwise.

The shift selector 302-m (m=1 to M−1) outputs the value of a vector register 304-(m+1) in response to a valid shift command, and outputs the value of a vector register 304-m otherwise. The shift selector 302-N outputs a zero vector in response to a valid shift command, and outputs the value of a vector register 304-M otherwise. That is, in response to a valid shift command, the values of the vector registers 304-1 to 304-M are shifted.

The addition command and the shift command represent control signals independently variable in units of clock cycles. In response to a valid shift command, the shift adder 300 outputs the value of the vector register 304-1 as an output vector representing a result of the shift addition.

Returning to FIG. 1, the vector computing unit 400 performs vector-based processing. For example, the vector computing unit 400 performs a vector operation, as instructed by the controller 11, to the vector (temporary vector) output from the shift adder 300, and outputs an output vector indicating a result of the vector operation.

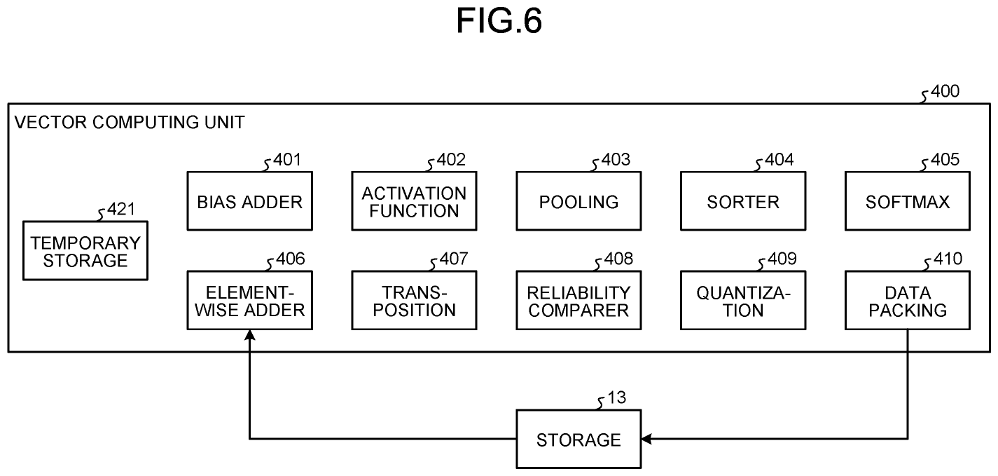

FIG. 6 is a block diagram illustrating an exemplary configuration of the vector computing unit 400. The vector computing unit 400 includes a temporary storage 421, a bias adder 401, an activation function 402, a pooling 403, a sorter 404, a softmax 405, an element-wise adder 406, a transposition 407, a reliability comparer 408, a quantization 409, and a data packing 410.

The bias adder 401 serves to add fixed bias values for use in a convolution operation and a batch normalization, for example. The bias adder 401 uses, for example, bias values stored in the temporary storage 421, the storage 13, or a register (not illustrated) for the addition.

The activation function 402 performs, for example, nonlinear function such as a ReLu function.

The pooling 403 serves to perform, for example, pooling such as maximum pooling (MaxPooling). The pooling is typically a two-dimensional pooling process. Thus, the pooling 403 uses consecutive input vectors to perform row-by-row one-dimensional pooling, and stores a result of the calculation in the temporary storage 421. The pooling 403 performs two-dimensional pooling using a result of one-dimensional pooling to a next row and the value stored in the temporary storage 421, and stores a result of the calculation in the temporary storage 421, outputs the result from the pooling 403, or outputs the result from the pooling 403 and stores the result in the temporary storage 421. The pooling 403 sequentially performs such processing to each row to complete two-dimensional pooling of an optional size.

The sorter 404 serves to sort data. The data sorting refers to, for example, a process of returning a block-interleaved order of input data with respect to the horizontal coordinates of feature map data to a consecutive order in a deconvolution operation (such as deconvolution or transposed convolution), using the temporary storage 421.

The softmax 405 performs one-dimensional softmax processing to feature map data in the horizontal direction by K parallel kernel computation of consecutive input vectors. In the softmax processing, maximum values are generally computed so as to ensure computational accuracy, however, it is not possible to know the maximum values in advance. It is also not possible to compute a denominator in advance. In this regard, the softmax 405 may also be configured to repeat the following processing three times. The processing before the softmax 405 is also repeated without change. In the repeated three processes, the softmax 405 obtains a maximum value in the first process, computes a denominator in the second process, and computes a softmax value from the maximum value and the denominator in the third process.

First process: xₘₐₓ=max(xₘₐₓ, xᵢₙ)

Second process: xₜₘₚ=exp(xᵢₙ−xₘₐₓ), xₛᵤₘ=xₛᵤₘ+xₜₘₚ

Third process: softmax value=xₜₘₚ/xₛᵤₘ

The element-wise adder 406 serves to add the input vector and the feature map data stored in the storage 13. The processing of the element-wise adder 406 corresponds to, for example, a branch path addition process in a neural network such as a residual network (ResNet).

The transposition 407 serves to perform transposition of input vectors. For example, the transposition 407 prepares registers that store therein K consecutive vectors of a size K, to write values to all the K×K registers and then read the values in units of vectors of a size K in the direction of transposition.

The quantization 409 serves to convert a data format. For example, the quantization 409 converts the format of K elements in the same vector into one piece of exponent data and K pieces of fixed-point format data with a reduced number of bits. For example, assuming that the K elements before the conversion be in the fixed-point format of B-bits, the quantization 409 first converts the K elements into a signed magnitude format to obtain K magnitude values of (B-1)-bits.

Next, the quantization 409 computes OR of corresponding bits of the K magnitude values to acquire (B−1)-bit OR data. The quantization 409 obtains the position of a bit of the OR data that first turns to one as viewed from a high-order bit side. The quantization 409 cuts outs (C−1) bits at the obtained position as a most significant bit (MSB) to obtain a quantized magnitude value. The quantization 409 may obtain the value of the MSB from which (C−1) bits are cut out, by rounding off the MSB of the bits to be cut off in the calculation of the magnitude value. The sign bit is invariable before and after the conversion.

The exponent data refers to a D-bit scalar obtained by adding a fixed value to an exponent (or its negative number) at the position of the MSB bit that first turns to one. By such quantization processing, the use amount of the storage 13 can be decreased and the matrix-product computing unit 100 can be decreased in circuit scale. For example, when K is set to 16, B is set to 16, C is set to 8, and D is set to 5, a memory required for storing vectors for use in computation is decreased in size through the quantization by about 48% from 256 bits (=K×B) to 133 bits (=K×C+D).

The data packing 410 serves to write input vectors to the storage 13 in a format matching the format of the storage 13. For example, the data packing 410 combines M vectors of a size K, converts the M vectors into the format of the feature map matrix of a size M×K (=M×P), and writes the M vectors in the storage 13. Thus, the write format and the read format with respect to the storage 13 is the same, which can facilitate consecutive layer processes in a neural network, for example.

The reliability comparer 408 serves to compare reliabilities when obtained by the computation process. For example, the computation process of the present embodiment is applied to object detection using a neural network. In this case, the reliability comparer 408 compares a threshold value and a difference in reliability between a target of the object detection and an object other than the target at each coordinate value of the feature map data. The reliability comparer 408 outputs information indicating a result of the detection of the target only at a value of the coordinate exhibiting a larger difference than the threshold value. The reliability comparer 408 may output an output vector including position information indicating a value of the coordinate exhibiting a larger difference than the threshold value. The output of the reliability comparer 408 is stored in, for example, the storage 13 or the temporary storage 421.

The controller 11 can disable the functions of the respective constituent elements (the bias adder 401, the activation function 402, the pooling 403, the sorter 404, the softmax 405, the element-wise adder 406, the transposition 407, the reliability comparer 408, the quantization 409, and the data packing 410) of the vector computing unit 400 when appropriate. The vector computing unit 400 may be configured not to include at least part of the constituent elements.

Further, the order in which the constituent elements of the vector computing unit 400 perform processing is not limited to any order. The controller 11 may be configured to be able to control the constituent elements such that constituent elements for use in a computation process to be implemented perform processing in an appropriate order. Also, the number of each constituent element may be two or more. For example, the vector computing unit 400 may include a plurality of activation functions 402 as constituent elements.

The controller 11 sets and controls parameters for the respective constituent elements (the storage 13, the transfer unit 12, and the computing unit 31), to be able to implement various computations. The following will describe an example of computation process to be implementable in the present embodiment.

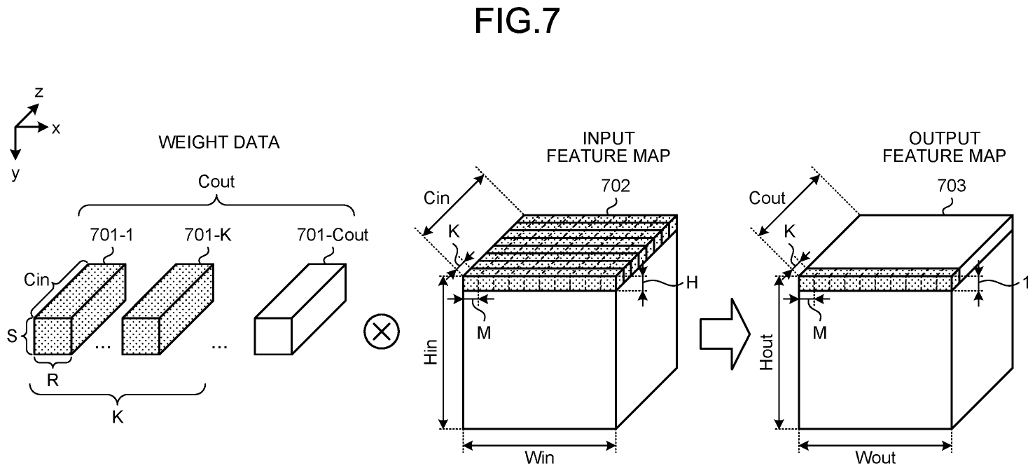

FIG. 7 is a diagram illustrating an example of the convolution operation by the computing device 10. In FIG. 7, three dimensions “x, y, z” represent the horizontal direction, the vertical direction, and the channel direction in the feature map data and the weight data. In the present embodiment, the horizontal direction (x-axis) and the vertical direction (y-axis) are interchangeable.

In FIG. 7, feature map data to be input is represented as an input feature map 702. The sizes of the input feature map in the x-axis, y-axis, and z-axis directions are defined as Win, Hin, and Cin, respectively. Hereinafter, the x-axial, y-axial, and z-axial sizes may be represented as a size (Win, Hin, Cin). The weight data includes Cout weight kernels 701-1 to 701-Cout of a size (R, S, Cin) in the x-axis, y-axis, and z-axis directions. K weight kernels are selected from the weight data for use in the computation process.

The unit of processing an output feature map 703, as the feature map data that the computing unit 31 consecutively computes at a time for output, is one-row K kernels as indicated by shading in FIG. 7. That is, the controller 11 consecutively reads weight matrices and feature map matrices to compute one-row K kernels and input them to the computing unit 31.

In FIG. 7, the alphabet H denotes the number of rows (y-axial size) of the input feature map required for the calculation of one row of the output feature map. H is equal to the y-axial size S of the weight kernel except for the top and bottom ends of the output feature map when the size (kernel size) of the weight kernel is greater than one and a padding process is involved.

The K weight vectors 22-1 to 22-K in FIG. 2 correspond to vectors of a size (1, 1, K), cut out from the same (x, y, z) coordinates of the K weight kernels (for example, the weight kernels 701-1 to 701-K) in FIG. 7.

The feature map matrix in FIG. 2 corresponds to data of a size (M, 1, K) having an even number (or odd number) on the x-axis in one block of a size (M, 1, K) or two blocks of a size (2M, 1, K) in FIG. 7. The latter corresponds to, for example, processing when the horizontal stride of the convolution operation is an even number (for example, two).

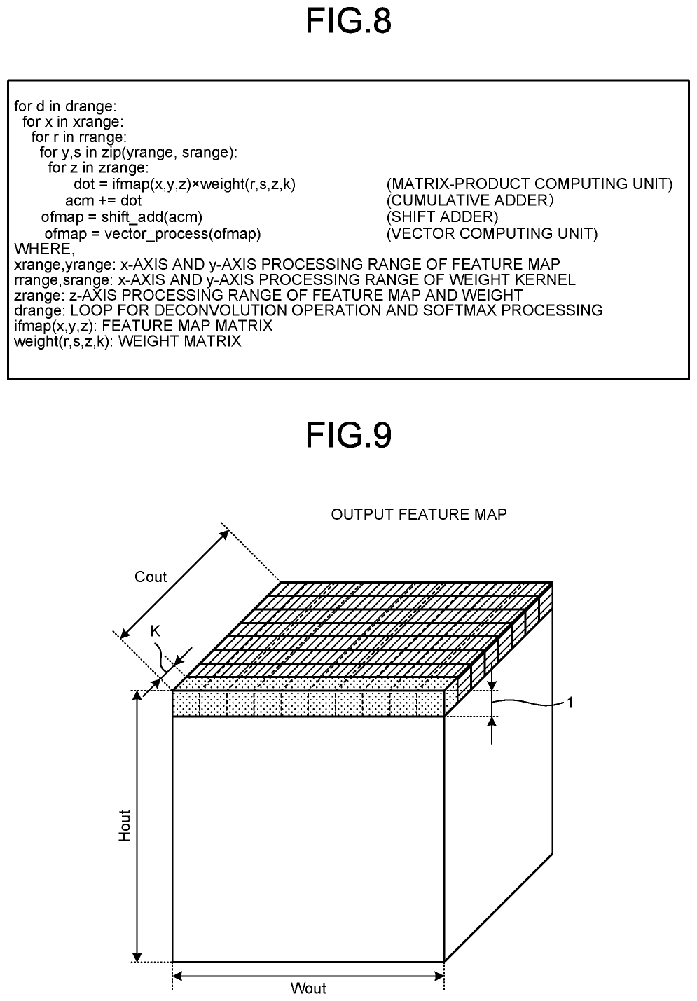

FIG. 8 is a diagram illustrating an exemplary pseudo programming code for use in a computing method by the computing unit 31. As illustrated in FIG. 8, the processing of the computing unit 31 has a five-dimensional processing loop structure. The five-dimensional processing loop structure refers to nested processing of five iterative processes. In performing one-dimensional processing to five-dimensional processing from inside to outside, the five-dimensional processing loop structure can be configured to be a simple repetition of the following processing:

One dimension: z-axis, that is, a loop in the channel direction (common to feature maps and weights);

Two dimension: y-axis and s-axis, that is, a loop in the vertical direction (y-axis: feature maps and s-axis: weights)

Three dimension: r-axis, that is, a horizontal loop of weights;

Four dimension: x-axis, that is, a horizontal loop of feature maps; and

Five dimension: d-axis, that is, a loop for softmax processing or a loop for sub-kernel selection in a deconvolution operation.

The order of the one-dimensional (z-axis) processing and the two-dimensional (y-axis and s-axis) processing can be exchanged. The deconvolution operation will be described in detail later.

In view of resolving the processing with respect to the weight data, the matrix-product computing unit 100 first processes a part (size (1, 1, K)) of the weight kernels on the z-axis. Next, the cumulative adder 200 processes the weight kernels in the z-axis direction and the y-axis (s-axis) direction. The shift adder 300 then processes the weight kernels in the x-axis (r-axis) direction. Combining these processes completes the overall processing with respect to the weight kernels. By consecutively performing such processes to the feature maps in the x-axis direction, the output feature map of the one-row K kernels can be completed. In the output feature map, M elements are computed in parallel in the x-axis direction. Except for the kernel size (R×S) being 1×1, not all the M elements are completed in the x-axis loop. The values of the vector registers 304-1 to 304-M of the shift adder 300 are carried over as initial values to output the rest in the next process of the x-axis loop.

In FIG. 8, “dot” denotes a matrix representing a result of computation by the matrix-product computing unit 100. “acm” denotes a matrix representing a result of computation by the cumulative adder 200. “shift_add( )” represents a function representing computation by the shift adder 300. “ofmap” denotes an output feature map representing a result of computation by the shift adder 300 or the vector computing unit 400.

The controller 11 performs various kinds of computation by adjusting the setting of the following parameters as illustrated in FIG. 8:

xrange and yrange: x-axis and y-axis processing ranges of feature map;

rrange and srange: processing ranges of weight kernel on x-axis and y-axis (rrange represents a function of d in deconvolution operation);

zrange: processing range of feature map and weight on z-axis: and

drange: loop for deconvolution operation and softmax processing.

In the exemplary convolution operation in FIG. 7, the parameters can be set as follows:
xrange=Win/M,
yrange=H,
rrange=R,
srange=S, and
zrange=Cin/K.

By performing the computation process as described above, the controller 11 can consecutively perform the computation processes, such as a convolution operation, a deconvolution operation, and a matrix operation, to one-row K kernels, without using an intermediated memory (memory for storing partial sums, for example).

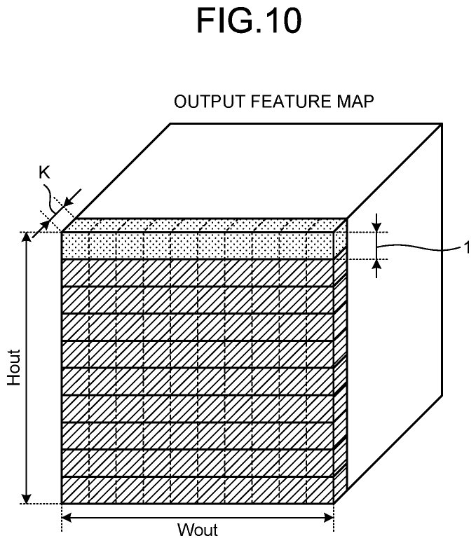

FIG. 9 and FIG. 10 are diagrams illustrating examples of computing scheduling by the computing device 10. FIG. 9 and FIG. 10 illustrate an exemplary first computing scheduling and an exemplary second computing scheduling, respectively. In the first computing scheduling, the computing device 10 sequentially performs computations in the channel direction in units of one-row K kernels to complete one row. In the second computing scheduling, the computing device 10 sequentially performs computations in units of one-row K kernels in the row direction to complete the K kernels.

The computing device 10 can select either of the two scheduling methods according to the shapes of feature maps and weights to be processed. There are two kinds of data arrangement of the feature maps in the storage 13, corresponding to the two kinds of computing scheduling. FIG. 9 illustrates an example that pieces of data in a minimum unit of a size (M, 1, K) are arranged in the order of x-axis, z-axis, and y-axis. FIG. 10 illustrates an example that pieces of data in a minimum unit are arranged in the order of x-axis, y-axis, and z-axis. The data arrangement of the feature maps in the storage 13 is predetermined in this manner, so that the controller 11 can easily compute and read the addresses of the feature map at all the coordinates.

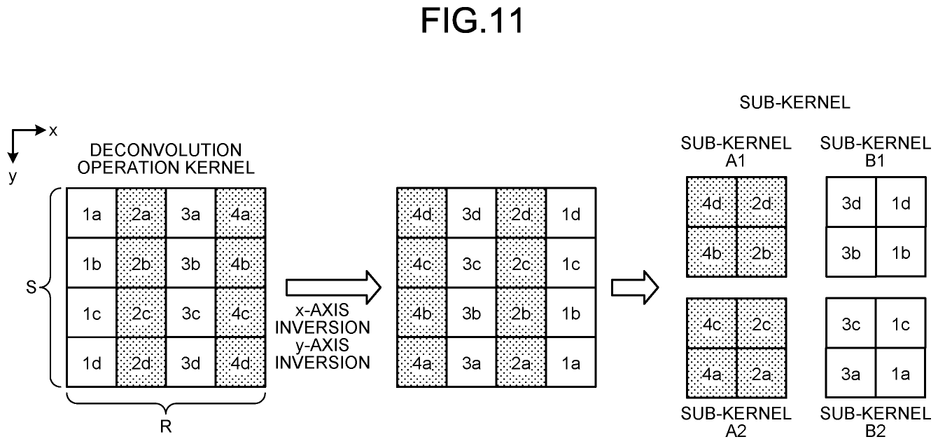

Next, the deconvolution operation will be described. FIG. 11 is a diagram for explaining a method of dividing a weight kernel into sub-kernels in the deconvolution operation. By converting a weight kernel into sub-kernels, the deconvolution operation can be resolved into a plurality of convolution operations. The computing device 10 resolves the deconvolution operation into a plurality of sub-kernels to perform a convolution operation. FIG. 11 illustrates an exemplary resolution on the x-axis and the y-axis alone and omits illustrating a resolution on the z-axis (in the channel direction). In the example of FIG. 11, in the x-axis and y-axis directions, a kernel having a size (4, 4) and a stride (2, 2) is divided into four sub-kernels of a size (2, 2). These sub-kernels have a stride (1, 1) in the x-axis and y-axis directions.

In the conversion into sub-kernels, first, the coordinates (sequence) of the weight kernel of the deconvolution operation are inverted on each of the x-axis and the y-axis. Next, the weight kernel is divided into sub-kernels by selecting elements in units of strides on each of the x-axis and the y-axis. For example, in the case of the weight kernel having a size (8, 8) and a stride (4, 4), the weight kernel is divided into 16 sub-kernels of a size (2, 2).

The d-axis processing loop illustrated in FIG. 8 is for selecting one of the sub-kernels in the x-axis direction in the deconvolution operation. That is, in the example of FIG. 11, the d-axis processing loop serves to select one of a sub-kernel A1 and a sub-kernel B1 (or a sub-kernel A2 and a sub-kernel B2). The size of “drange” is equal to the stride size on the x-axis. The size of the sub-kernel is equal to a value obtained by dividing the original kernel size by the stride size. Whether to use the set of the sub-kernels A1 and B1 or the set of the sub-kernels A2 and B2 is determined by a row number of an output feature map to be computed, and the two sets are used in order on a row basis.

In the deconvolution operation, the processing loop inside the d-axis processing loop of FIG. 8 is processed using the selected sub-kernels in the same manner as a normal convolution operation. However, as illustrated in FIG. 7, in order to sort the output feature map of one row and K columns in the order of x-axis coordinates, the sorter 404 is to sort the output feature maps computed in units of sub-kernels.

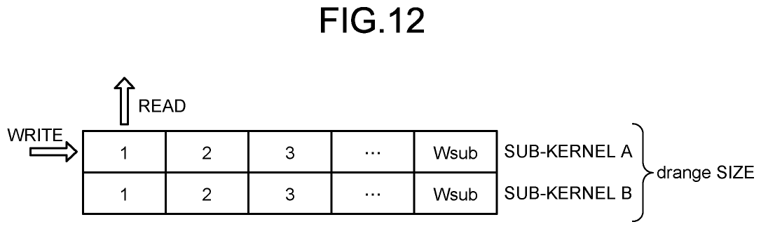

FIG. 12 is a diagram illustrating an exemplary data sorting process in the deconvolution operation by the sorter 404. FIG. 12 illustrates an example of sorting feature map vectors with “drange” having a size of 2 and each rectangular box having a size (1, 1, K). One row of FIG. 12 shows a result of processing one sub-kernel of the deconvolution operation. “Wsub” represents the x-axial size (Wsub=Wout/drange size) of the output feature map computed using the sub-kernel. As illustrated in FIG. 12, the sorter 404 performs sorting by writing data in a unit of rows and reading data in a unit of columns. By performing such sorting, in the deconvolution operation the sorter 404 can set the data sequence of output feature maps to be written in the storage 13 in the same order as the x-axis coordinates.

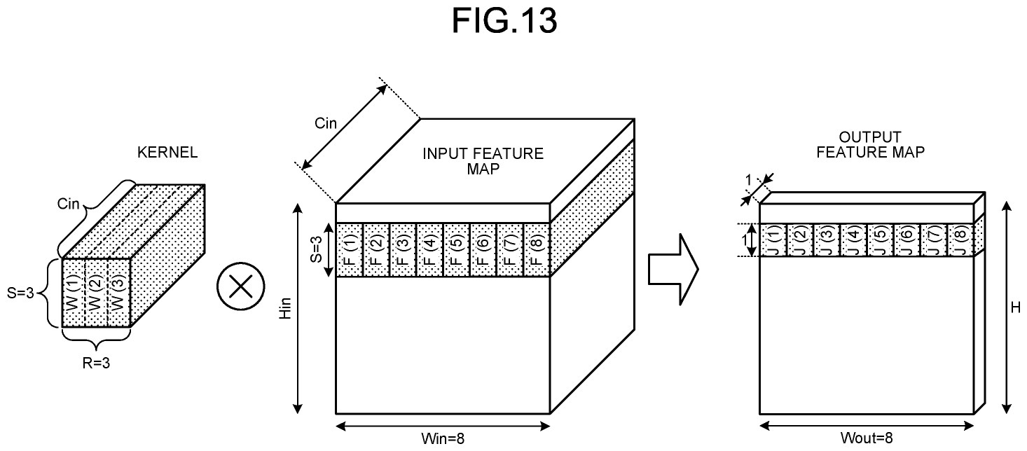

FIG. 13 is a diagram illustrating an exemplary convolution operation by the shift adder 300. FIG. 13 illustrates an example of executing a convolution operation in which an input feature map and an output feature map have the same size in the x-axis and y-axis directions, the x-axial and y-axial size (R, S) of a kernel is (3, 3), an x-axial and y-axial stride is set to (1, 1), and an x-axial and y-axial padding is set to (1, 1).

In FIG. 13, W(n) represents a range of a kernel with an x-coordinate at n and a size (1, S, Cin) where n is 1 to 3. Similarly, F(n) represents a range of a feature map with an x-coordinate at n (n is 1 to Win) and a size (1, S, Cin). J(n) (n is 1 to Wout) represents an output feature map with an x-coordinate at n and a size (1, 1, 1). In reality K kernels are subjected to such processing in parallel, however, for the sake of simplification, the number of output channels is set to 1 in FIG. 13.

The output feature map J(n) can be expressed by Formula 1 below using W(n) and F(n):

$$J ( n ) = {\sum }_{i = 1}^{R} < F ( n - offset + i ) , W ( i ) > \qquad ( 1 )$$

where F(n) represents 0 (n<0 or n>Win), offset represents 2, and <F(n), W(M)> represents a value obtained by adding all the element products of F(n) and W(M). <F(n) and W(M)> correspond to an input to the shift adder 300. The kernels are processed in order from right to left along the x-axis.

First, while the addition command is valid, <F(1), W(3)> to <F(M), W(3)> are not input to the shift adder 300 and are assigned to the vector registers 304-1 to 304-M instead. The initial values of the vector registers 304-1 to 304-M are set to zero. Next, while the addition command and the shift command are both valid, <F(1), W(2)> to <F(M), W(2)> are input to the shift adder 300. Lastly, while the addition command and the shift command are both valid, <F(1), W(1)> to <F(M), W(1)> are input to the shift adder 300. The values of the vector registers 304-1 to 304-M−1 now indicate completed output feature maps J(1) to J(M−1). However, completion of J(M) requires F(M+1), therefore, J(M) is incomplete in the vector register 304-M.

Next, in response to a (M−1)-th shift command, the output feature maps J(1) to J(M−1) are output from the shift adder 300. At the same time, the value of the vector register 304-M is transferred to the vector register 304-1 and the values of the rest of the vector registers 304-1 to 304-(M−1) are initialized to zero.

The next M input feature maps F(M+1) to F(2M) are subjected to the same processing. While the addition command is valid, <F(M+1), W(3)> to <F(2M), W(3)> are added to the vector registers 304-1 to 304-M of the shift adder 300. Thereby, the output feature map J(M) in the vector register 304-M is completed.

Through repetition of the above processing, the output feature map of the one-row K kernels is completed, as illustrated in FIG. 7.

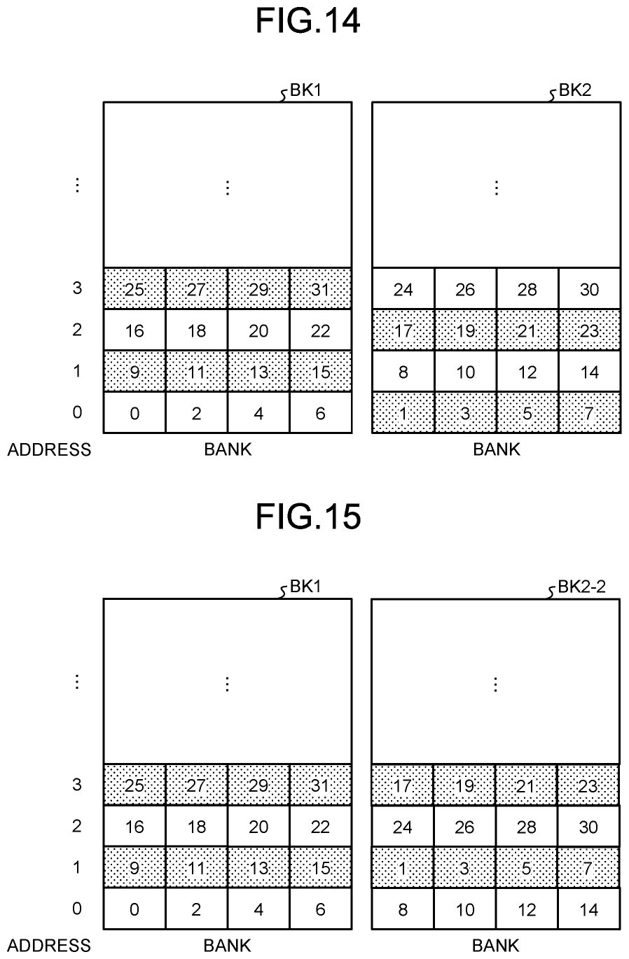

The following will describe examples of data arrangement in the storage 13. FIG. 14 and FIG. 15 are diagrams illustrating first and second examples of data arrangement in the storage 13, respectively. In FIG. 14 and FIG. 15 each box represents a feature map of a size (1, 1, K). One word is set to a size (M, 1, K) where M represents eight. The numerical value in each box indicates an x-axis value.

The storage 13 includes two banks (memory banks) inside and the banks are independently readable and writable. In the first example (FIG. 14), the storage 13 includes banks BK1 and BK2. In the second example (FIG. 15), the storage 13 includes banks BK1 and BK2-2. In both the first and second examples, the x-axis value at the same address of each of the two banks is either an odd number or an even number.

The first example and the second example are different from each other in that data at even-numbered addresses and data at odd-numbered addresses are switched between the banks BK2 and BK2-2. In both examples, the two banks are independently accessible.

By such data arrangement, the computing device 10 can read, in each cycle, data corresponding to a M×P feature map matrix having even-number values alone (or odd numbers alone) at x-axis coordinates in the case of an even-number stride (particularly, two) of the convolution operation.

In the first example, in the convolution operation of stride at 1, data is read from the same addresses in both the bank BK1 and the bank BK2, for example. In reading even-numbered data in the convolution operation of stride at 2, the bank BK1 has even-numbered addresses, and the bank BK2 has odd-numbered addresses that are inverted from the least significant bits (LSB) of the addresses of the bank BK1. Similarly, in reading odd-numbered data, the bank BK1 has odd-numbered addresses, and the bank BK2 has even-numbered addresses that are inverted from the LSBs of the addresses of the bank BK1.

Owing to such a configuration, the computing device 10 can read a feature map matrix of a size to be input to the computing unit 31 in every cycle irrespective of whether the stride is one or two, and implement efficient processing.

The computation processing described above can be configured to be included in a plurality (Q where Q is an integer of two or more) of layer processes. The layer refers not to a single computation process such as a convolution operation but to a series of processes including the processing of the vector computing unit 400 of the present embodiment, such as a convolution operation (or a deconvolution operation or a matrix multiplication) and subsequent pooling.

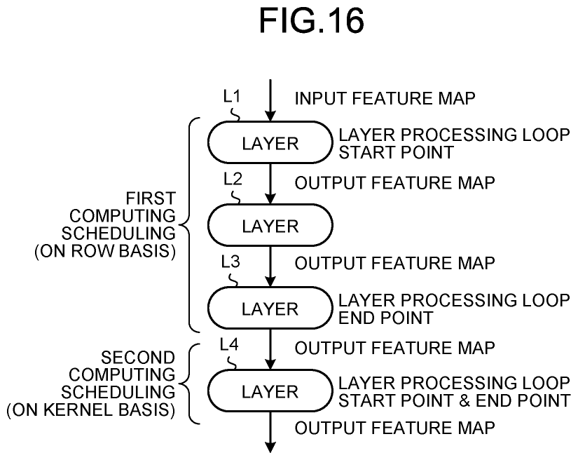

Hereinafter, exemplary processing including a plurality of layers will be described. The processing including the layers refers to, for example, processing using a neural network. FIG. 16 is a diagram illustrating an exemplary graph of a neural network including four layers.

The layers are configured as follows, as an example:

First layer: performs computation using input feature maps (first input feature data) to output output feature maps (first output feature data);

q-th layer (2≤q≤Q where Q is an integer of two or more): performs computation using output feature maps (q-1-th output feature data) output from the q-1-th layer as input feature maps (q-th input feature data) to output output feature maps (q-th output feature data).

The controller 11 can control the multiple layer processes as above in the following manner. That is, the controller 11 controls the five-dimensional processing loop so as to start computing partial data of the q-th output feature data upon obtaining part or whole of the q-1-th output feature data required for the computation of the q-th output feature data, which will be described below as an example.

The controller 11 defines a start point and an end point of the layer processing loop in the graph of the neural network, and defines the flow of computation processes in a unit of loops of the layer processing (referred to as a layer processing loop).

In the example of FIG. 16, layers L1 to L3 are to be processed together as one layer processing loop. Layer L4 is a layer processing loop to be processed independently. The layers L1 to L3 correspond to the layers in which the processing proceeds in a unit of rows of an output feature map following the first computing scheduling. The layer L4 corresponds to the layer in which the processing proceeds in a unit of kernels following the second computing scheduling. Typically, by processing the layers together following the first computing scheduling, the controller 11 can collectively and consecutively perform the processing up to a layer with an output feature map of a smaller size. This makes it possible to reduce the memory usage of the storage 13 and data transfer to and from an external memory, as compared with performing every layer processing. The external memory refers to a storage device located outside the computing device 10.

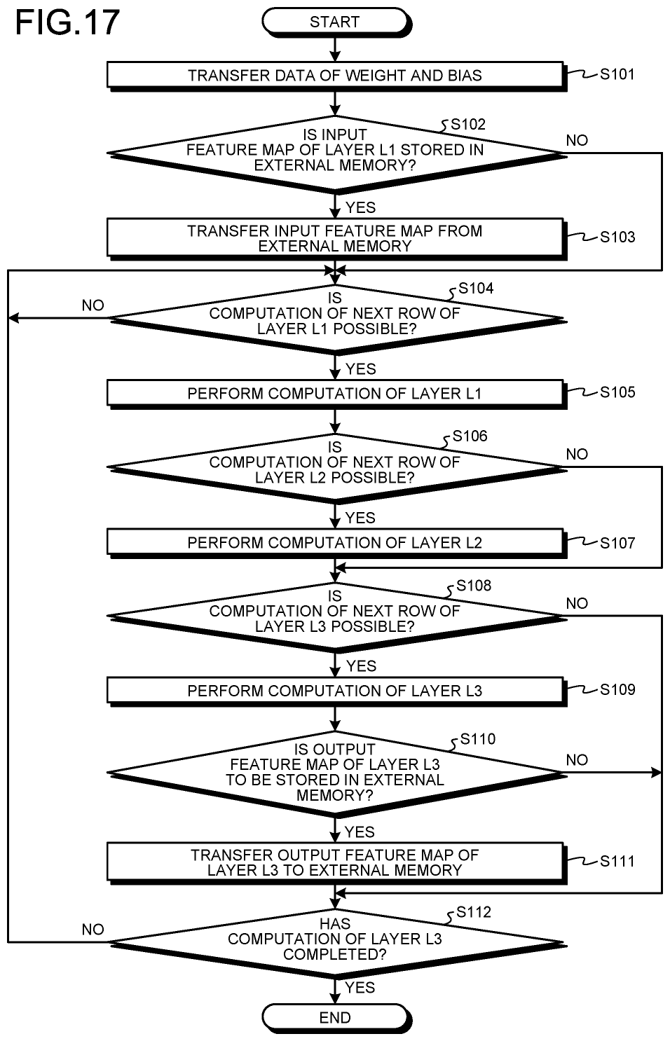

FIG. 17 is a flowchart illustrating an example of computation process in the layers L1 to L3 of FIG. 16 by the computing device 10. FIG. 17 illustrates an example that the number of layers to be collectively processed is three (L 3). The same procedure is also applicable to two or four or more layers.

First, the controller 11 transfers weights and bias values of the layers L1 to L3 from the external memory to the computing device 10 (step S101). For example, the controller 11 performs data transfer by sending a data transfer command to the transfer unit 12.

Next, the controller 11 determines whether the input feature maps of the layer L1 are stored in the external memory (step S102). After determining that the input feature maps of the layer L1 are stored in the external memory (Yes at step S102), the controller 11 starts transferring data of the input feature maps from the external memory to the computing device 10 (step S103).

After starting transferring the input feature maps of the layer L1 or with no input feature maps of the layer L1 stored in the external memory, that is, with the input feature maps of the layer L1 stored in the storage 13 (No at step S102), the controller 11 transitions to step S104.

The controller 11 includes a function of temporarily interrupting the data transfer in order to prevent input feature maps to be used from being overwritten or deleted from the storage area of the storage 13 allocated to the input feature maps of the layer L1, the progress of data transfer, and the progress of computation process. For example, in the case of using an advanced extensible interface (AXI) bus, the controller 11 can easily implement the transfer interruption function on a cycle-by-cycle basis by deasserting a RREADY signal.

In step S104, the controller 11 determines whether an input feature map and weights required for calculating an output feature map of a next row of the layer L1 are ready (step S104). After determining that the input feature map and the weights are ready (Yes at step S104), the controller 11 performs the computation process of the layer L1 (step S105). After determining that the input feature map and the weights are not yet ready (No at step S104), the controller 11 waits for necessary data to be ready to execute a computation.

Necessary data, i.e., an input feature map and weights for calculating an output feature map of a next row is an example of partial data. The same applies to the following processing.

Next, the controller 11 determines whether an input feature map of the layer L2 (=the output feature map from the layer L1) required for calculating an output feature map of a next one row of the layer L2 is ready (step S106). After determining that the input feature map is ready (Yes at step S106), the controller 11 performs the computation process of the layer L2 (step S107). After determining that the input feature map is not yet ready (No at step S106), the controller 11 proceeds to step S108, skipping the computation process of the layer L2.

Similarly, the controller 11 determines whether an input feature map of the layer L3 (=the output feature maps from the layer L2) required for calculating an output feature map of a next one row of the layer L3 is ready (step S108). After determining that the input feature map is ready (Yes at step S108), the controller 11 performs the computation process of the layer L3 (step S109). After determining that the input feature map is not yet ready (No at step S108), the controller 11 proceeds to step S112, skipping the computation process of the layer L3.

After executing the computation process of the layer L3, the controller 11 determines whether the output feature map of the layer L3 is stored in the external memory (step S110). After determining that the output feature map of the layer L3 is stored in the external memory (Yes at step S110), the controller 11 transfers one row of the computed output feature map of the layer L3 to the external memory (step S111). After the transfer or with no output feature map of the layer L3 stored in the external memory (No at step S110), the controller 11 proceeds to step S112.

In step S112, the controller 11 determines whether the computation process of the layer L3 has ended, that is, all the output feature maps of the layer L3 have been completed (step S112). After determining incompletion of the output feature maps of the layer L3 (No at step S112), the controller 11 returns to step S104 and repeats the processing from a next row. After determining completion of all the output feature maps of the layer L3 (Yes at step S112), the controller 11 ends the computation processes of the layers L1 to L3.

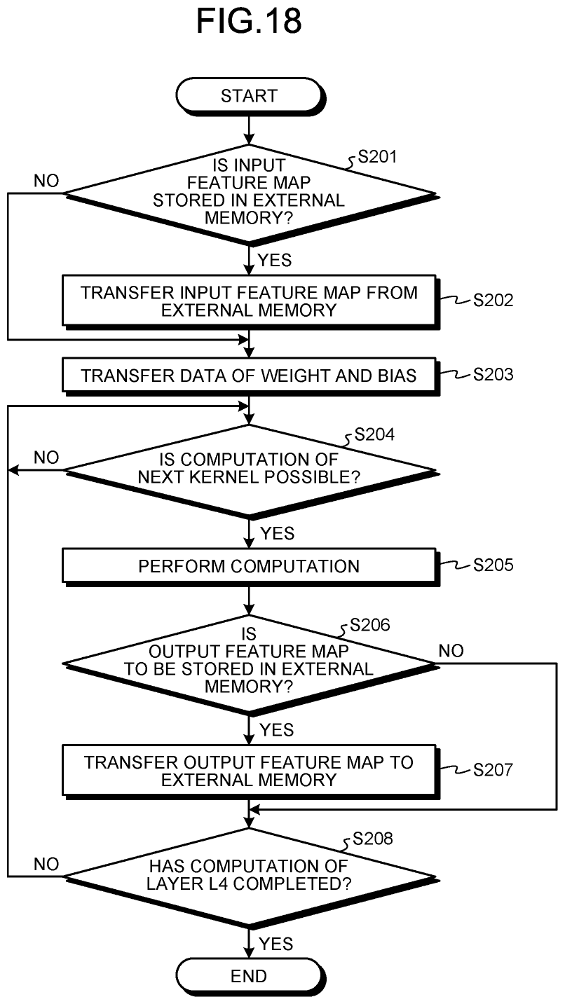

FIG. 18 is a flowchart illustrating an example of computation process in the layer L4 of FIG. 16 by the computing device 10.

First, the controller 11 determines whether the input feature map of the layer L4 is stored in the external memory (step S201). After determining that the input feature map of the layer L4 is stored in the external memory (Yes at step S201), the controller 11 starts transferring data of the input feature map from the external memory to the computing device 10 (step S202).

After transferring the input feature map of the layer L4, or with no input feature map of the layer L4 stored in the external memory (No at step S201), that is, with the input feature map of the layer L4 stored in the storage 13, the controller 11 transitions to step S203.

Next, the controller 11 starts transferring data of the weights and bias values of the layer L4 from the external memory to the computing device 10 (step S203).

The controller 11 has a function of temporarily interrupting the data transfer when appropriate in order to prevent weights to be used from being overwritten or deleted from the storage area of the storage 13 allocated to the weights of the layer L4, the progress of data transfer, and the progress of computation process.

The controller 11 determines whether weights required for calculating an output feature map of next K kernels of the layer L4 is ready (step S204). After determining that the weights are ready (Yes at step S204), the controller 11 executes the computation process of the layer L4 (step S205) After determining that the weights are not yet ready (No at step S204), the controller 11 returns to the determination in step S204 and waits for the weights to be ready.

The controller 11 determines whether the output feature map of the layer L4 is stored in the external memory (step S206). After determining that the output feature map of the layer L4 is stored in the external memory (Yes at step S206), the controller 11 transfers the computed output feature map of the layer L4 to the external memory (step S207). After the transfer or with no output feature map of the layer L4 stored in the external memory (No at step S206), the controller 11 proceeds to step S208.

The controller 11 determines whether the computation process of the layer L4 has ended, that is, all the output feature maps of the layer L4 are completed (step S208). After determining incompletion of the output feature maps of the layer L4 (No at step S208), the controller 11 returns to step S204 and repeats the processing from a next kernel. After determining completion of all the output feature maps of the layer L4 are completed (Yes at step S208), the controller 11 ends the computation process of the layer L4.

As described above, according to the computing device of the present embodiment, the controller 11 controls the matrix-product computing unit 100, the cumulative adder 200, the shift adder 300, and the vector computing unit 400 using the five-dimensional processing loop, to execute computation such as a convolution operation. Thereby, the computing device can execute computation processes of a neural network in parallel with higher efficiency, for example.

Computer programs executed by the computing device of the present embodiment is incorporated and provided in the storage 13, for example.

The computer programs executed by the computing device of the present embodiment may be recorded in an installable or executable file format on a computer-readable recording medium, such as a compact disc read-only memory (CD-ROM), a flexible disk (FD), a compact disc recordable (CD-R), and a digital versatile disc (DVD) and be provided as a computer program product.

Moreover, the computer programs executed by the computing device of the present embodiment may be stored on a computer connected to a network such as the Internet and provided by being downloaded via the network. The computer programs executed by the computing device according to the present embodiment may be provided or distributed via the network such as the Internet.

The computer programs executed by the computing device of the present embodiment can cause the computer to serve as the respective elements of the computing device as above. In this computer, the controller 11 can load and execute the computer programs from the computer-readable recording medium onto a main storage device.

While certain embodiments are described, these embodiments are presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computing device comprising:
processing circuitry configured to:
compute an M×K-dimensional first output matrix in response to a matrix product operation instruction, the M×K-dimensional first output matrix being a product of an M×P-dimensional first input matrix and a P×K-dimensional second input matrix where M, K, and P each represents an integer of two or more,
compute an M×K-dimensional cumulative addition matrix in response to a cumulative addition instruction, and store the M×K-dimensional cumulative addition matrix in a cumulative register, the M×K-dimensional cumulative addition matrix representing a matrix obtained by adding the first output matrix and an M×K-dimensional matrix stored in the cumulative register,
compute, in response to a vector addition instruction, an addition vector by adding each of M-dimensional cumulative addition vectors included in the cumulative addition matrix and an M-dimensional temporary vector stored in each of M vector registers, store the addition vector in each vector register, and output the temporary vector from an M-th one of the vector registers in response to a shift instruction,
perform an instructed vector operation to the output temporary vector and output an output vector as a result of the vector operation; and
control circuitry configured to control the matrix product operation instruction, the cumulative addition instruction, the vector addition instruction, the shift instruction, and an instruction of the vector operation.

2. The device according to claim 1, wherein
the first input matrix includes M P-dimensional first input vectors,
the second input matrix includes K P-dimensional second input vectors,
each element included in the first input vectors is encoded by a fixed point an exponent position of which is specified by a first exponent value,
each element included in the second input vectors is encoded by a fixed point an exponent position of which is specified by a second exponent value,
the processing circuitry comprises M×K inner product multipliers, M×K exponent adders, and M×K bit shifters corresponding to an m-th first input vector and a k-th second input vector having different combinations, where m is 1≤m≤M and k is 1≤k≤K,
each of the inner product multipliers is configured to compute an inner product of the corresponding m-th first input vector and k-th second input vector,
each of the exponent adders is configured to compute an exponent value by adding the first exponent value of the corresponding m-th first input vector and the second exponent value of the corresponding k-th second input vector, and
each of the bit shifters is configured to bit-shift the inner product computed by the corresponding inner product multiplier, in accordance with the exponent value computed by the corresponding exponent adder.

3. The device according to claim 1, wherein
the first input matrix includes elements corresponding to M coordinates in a horizontal direction, one coordinate in a vertical direction, and P coordinates in a channel direction, among input feature data including elements as features at each three-dimensional coordinate value in the vertical direction, the horizontal direction, and the channel direction,
the second input matrix includes elements corresponding to P coordinates in the horizontal direction, one coordinate in the vertical direction, and K coordinates in the channel direction, among weight data including elements as weights at each four-dimensional coordinate value in the vertical direction, the horizontal direction, the channel direction, and a kernel direction,
the control circuitry controls computation using a five-dimensional processing loop including a first processing loop, a second processing loop, a third processing loop, a fourth processing loop, and a fifth processing loop from inside,
the first processing loop corresponds to one of a process of repeating the matrix-product computation in the channel direction and a process of repeating the cumulative addition in the vertical direction, and the second processing loop corresponds to the other of the processes,
the third processing loop corresponds to a process of repeating the matrix-product computation, the cumulative addition, the shift addition, and the vector computation in the horizontal direction of the weight data,
the fourth processing loop corresponds to a process of repeating a process included in the third processing loop in the horizontal direction of the input feature data, and
the fifth processing loop corresponds to a process of repeating a process included in the fourth processing loop a given number of times.

4. The device according to claim 3, wherein
the control circuitry controls computation of a plurality of layers including:
a first layer that performs a computation using first input feature data to output first output feature data; and
a q-th layer that performs a computation using, as q-th input feature data, q-1-th output feature data output from a q-1-th layer, to output q-th output feature data where q is 2≤q≤Q and Q is an integer of two or more, and
upon obtaining part or all of the q-1-th output feature data for use in a computation of partial data of the q-th output feature data, the control circuitry controls the five-dimensional processing loop so as to start the computation of the partial data.

5. The device according to claim 1, further comprising:
a storage configured to store therein input feature data including elements as features at each three-dimensional coordinate value in a vertical direction, a horizontal direction, and a channel direction, wherein
the storage comprises at least two memory banks, and
among the input feature data, the at least two memory banks store:
data having one of an even-number coordinate value and an odd-number coordinate value in the horizontal direction in an area designated by an even-numbered address, and
data having the other of the even-number coordinate value and the odd-number coordinate value in the horizontal direction in an area designated by an odd-numbered address.

6. The device according to claim 1, wherein
the vector operation includes vector-based pooling using a temporary storage and vector-based sorting using the temporary storage.

7. The device according to claim 1, wherein
the first input matrix includes elements corresponding to M coordinates in a horizontal direction, one coordinate in a vertical direction, and P coordinates in a channel direction, among input feature data including elements as features at each three-dimensional coordinate value in the vertical direction, the horizontal direction, and the channel direction, and
the vector operation includes a process of:
comparing, at each of the three-dimensional coordinate values, a threshold value and a difference in reliability between a target of detection and an object other than the target, the reliability being computed from the input feature data, and
outputting the output vector including position information indicating the three-dimensional coordinate value having the difference larger than the threshold value.

8. The device according to claim 1, wherein
the first input matrix includes elements corresponding to M coordinates in a horizontal direction, one coordinate in a vertical direction, and P coordinates in a channel direction, among input feature data including elements as features at each three-dimensional coordinate value in the vertical direction, the horizontal direction, and the channel direction, and
the vector operation includes a process of:
comparing, at each of the three-dimensional coordinate values, a threshold value and a difference in reliability between a target of detection and an object other than the target, the reliability being computed from the input feature data, and
outputting the output vector including information indicating a result of detection of the target, only at the coordinate value having the difference larger than the threshold value.

9. A computing method comprising:
computing an M×K-dimensional first output matrix in response to a matrix product operation instruction, the M×K-dimensional first output matrix being a product of an M×P-dimensional first input matrix and a P×K-dimensional second input matrix where M, K, and P each represents an integer of two or more;
computing an M×K-dimensional cumulative addition matrix in response to a cumulative addition instruction, and storing the M×K-dimensional cumulative addition matrix in a cumulative register, the M×K-dimensional cumulative addition matrix representing a matrix obtained by adding the first output matrix and an M×K-dimensional matrix stored in the cumulative register;
computing, in response to a vector addition instruction, an addition vector by adding each of M-dimensional cumulative addition vectors included in the cumulative addition matrix and an M-dimensional temporary vector stored in each of M vector registers, storing the addition vector in each vector register, and outputting the temporary vector from an M-th one of the vector registers in response to a shift instruction;
performing an instructed vector operation to the output temporary vector and output an output vector as a result of the vector operation; and
controlling the matrix product operation instruction, the cumulative addition instruction, the vector addition instruction, the shift instruction, and an instruction of the vector operation.
